(19) United States
(12) Patent Application Publication
(10) Pub. No.: US 2012/0013566 A1
(43) Pub. Date: Jan. 19, 2012

(54) PRESSURE SENSING MODULE OF TOUCH MODULE AND METHOD OF OPERATING THE SAME

(75) Inventor: Il Kwon Chung, Gyunggi-do (KR)

(73) Assignee: SAMSUNG ELECTRO-MECHANICS CO., LTD., Gyunggi-do (KR)

(21) Appl. No.: 12/901,948

(22) Filed: Oct. 11, 2010

(30) Foreign Application Priority Data
Jul. 13, 2010 (KR) 1020100067569

(51) Int. Cl. G06F 3/045

(52) U.S. Cl. 345/174

(57) ABSTRACT

Disclosed herein is a pressure sensing module of a touch panel, including: an input unit 100 that inputs a touch; a controller 200 that controls the sensing of pressure applied when touch is input; a camera module driver 300 that is driven by the controller 200; a calculator 400 that calculates a pressure value applied when the touch panel is touched by using the change at the touched surface sensed by the camera module driver 300; and an output value display unit 500 that displays an output value derived from the calculator 400. According to the present invention, the pressure applied when the central portion and edge portions of the touch panel are touched can be uniformly measured, even in the case of the large-sized touch panel.

### CROSS REFERENCE TO RELATED APPLICATION

This application claims the benefit of Korean Patent Application No. 10-2010-0067569, filed on Jul. 13, 2010, entitled “Pressure Sensing Module Of Touch Module and Method Of Operating The Same”, which is hereby incorporated by reference in its entirety into this application.

### BACKGROUND OF THE INVENTION

1. Technical Field

The present invention relates to a pressure sensing module of a touch panel and a method of operating the same.

2. Description of the Related Art

Alongside the growth of computers using digital technology, devices assisting computers have also been developed, and personal computers, portable transmitters and other personal information processors execute processing of text and graphics using a variety of input devices such as a keyboard, a mouse and so on.

While the rapid advancement of the information-based society has been widening the use of computers more and more, there have been occurring the problems of it being difficult to efficiently operate products using only the keyboard and mouse as being currently responsible for the input device function. Thus, the demand for a device which is simple, does not malfunction, and has the capability to input easily is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. Various types of touch panels are adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used.

Recently, the touch panel on which the pressure sensor is mounted has been used in order to optimize various functions of applications. The pressure sensors to measure a pressure applied when the touch panel is touched are mounted on the touch panel; however, most of the pressure sensors should be disposed at the outer edges of the touch panel in order to prevent the degradation in the visibility of the touch panel. In particular, when the pressure sensors are mounted on the large-sized touch panel, there is a problem in that the difference in sensing sensitivity at the central portion and edge portions of the touch panel occurs. In addition, in the case of the mainly used capacitive type in recent, a finger is generally used as a touch unit. Therefore, a need exists for a method to uniformly measure the pressure generated when a finger is touched on the touch panel at all positions.

### SUMMARY OF THE INVENTION

The present invention has been made in an effort to provide a pressure sensing module of a touch panel capable of calculating a pressure value by using a color change or a color changing area generated on a touched surface when being touched on a touch panel and a method of operating the same.

A pressure sensing module of a touch panel according to a preferred embodiment of the present invention includes: an input unit that inputs a touch; a controller that controls the sensing of pressure applied when touch is input; a camera module driver that is driven by the controller; a calculator that calculates a pressure value applied when the touch panel is touched by using the change at the touched surface sensed by the camera module driver; and an output value display unit that displays an output value derived from the calculator.

The controller determines whether the touch input is made by a finger and if it is determined that the touch input is made by the finger, drives the camera module driver and if it is determined that the touch input is made by input units other than the finger, ends the pressure sensing module.

The camera module driver senses the color changing area of the surface touched by the finger generated when the touch is made by the finger.

The camera module driver senses the color change at the touched surface generated when the touch panel is touched.

The camera module driver senses the color changing area at the touched surface generated when the touch panel is touched.

A method of sensing a pressure of a touch panel according to a preferred embodiment of the present invention includes: inputting touch; determining a touch input scheme; driving a camera module according to the determining; sensing a change at a touched surface generated when the touch panel is touched by the driving; calculating a pressure value applied when the touch panel is touched by using the change of the touched surface by the sensing; and displaying outputs of the calculated pressure value.

The determining the touch input scheme determines whether the touch input scheme changes colors according to the pressure applied when the touch panel is touched, if it is determined that the touch input scheme changes colors, the driving the camera module is performed, the sensing senses the color change at the touched surface when the touch is input by the driving of the camera module, the calculating calculates the pressure value by using the color change at the touched surface sensed by the sensing, and if it is determined that touch input schemes other than the touch input scheme changing the color are used, the pressure sensing of the touch panel ends.

The determining the touch input scheme determines whether the touch input scheme changes the color changing area according to the pressure applied when the touch panel is touched, if it is determined that the touch input scheme changes the color changing area, the driving the camera module is performed, the sensing senses the color changing area at the touched surface when the touch panel is touched by the driving, the calculating calculates the pressure value applied when the touch panel is touched by using the color changing area at the touched surface sensed by the sensing, and if it is determined that touch input schemes other than the touch input scheme changing the color changing area are used, the pressure sensing of the touch panel ends.

### BRIEF DESCRIPTION OF THE DRAWINGS

FIG. 1 is a diagram schematically showing a pressure sensing module of a touch panel according to the present invention; and

FIG. 2 is a flow chart showing a method of sensing a pressure of a touch panel according to an embodiment of the present invention.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

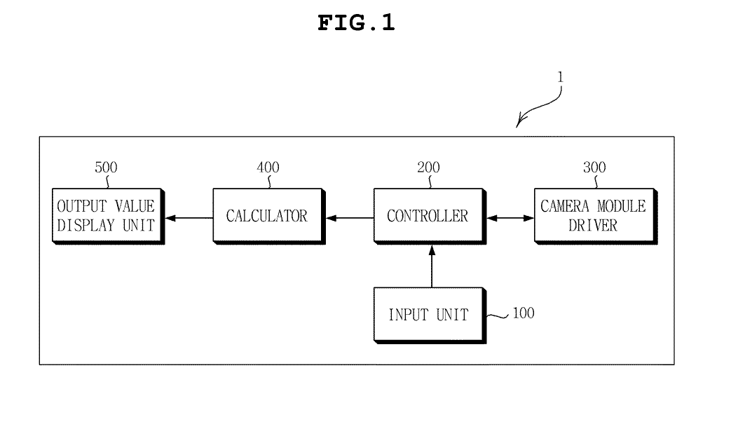

FIG. 1 is a diagram schematically showing a pressure sensing module of a touch panel according to the present invention. A pressure sensing module of a touch panel according to the present invention includes an input unit that inputs a touch, a controller that controls the sensing of pressure applied when touch is input, a camera module driver that is driven by the controller, a calculator that calculates a pressure value applied when the touch panel is touched by using the change at the touched surface sensed by the camera module driver, and an output value display unit that displays an output value derived from the calculator.

The input unit 100 for inputting a touch inputs a touch input value according to a touch scheme of a user. The touch can be input by various schemes. However, since the present invention senses the pressure applied when the touch panel is touched, it is preferable that the touch is input according to the touch scheme.

The controller 200 serves to control the sensing of the touch pressure applied when touch is input. In order to sense the pressure applied when the touch panel is touched, the method of sensing the pressure should be varied according to the determination as to what touch scheme is used. When the touch is made by a finger, a color is changed on the surface on which the finger is touched. As the pressure for a surface touched by the finger increases, the color changing area increases. The color changing area, etc., is sensed by driving the camera module. The controller 200 controls the pressure sensing according to the touch scheme in order to measure the pressure applied when the touch panel is touched by driving the camera module. The controller 200 determines whether the touch input scheme has visual changing factors at the touched surface that is correlated with the pressure applied when the touch panel is touched. In particular, the controller 200 senses the visual factors such as the color change, the color changing area, etc., at the touched surface that is correlated with the pressure change when the touch panel is touched by driving the camera module to calculate the touch pressure value. Therefore, the controller 200 determines the touch input scheme to perform a control to end the pressure sensing of the touch panel when the touch input scheme does not have the changing factors that is correlated with the pressure applied when the touch panel is touched, thereby enabling the pressure sensing according to the input unit.

The camera module driver 300 is driven if it is determined that the pressure sensing can be made by determining the touch input scheme in the controller 200. The camera module driver 300 senses the color change, the increase and decrease of the color changing area, and other visual factors on the touched surface when the touch panel is touched, thereby making it possible to calculate the pressure value that correlates therewith. The camera module driver 300 may be driven at various positions and is designed to be sensed at a proper position according to the targets to be sensed.

When the calculator 400 drives the camera module driver 300 according to the touch input scheme by the controller 200, the pressure is calculated by the visual information at various touched surfaces sensed by the camera module driver 300. The correlation between various visual changes such as the color change, the increase and decrease of the color changing area on the touched surface, etc., and the pressure applied when the touch panel is touched is calculated, such that the pressure value is accurately calculated without a separate pressure sensor, thereby outputting data to the output value display unit according to the calculated pressure value.

The output value display unit 500 displays an output value according to the pressure value measured by the calculator 400. In particular, in various applications differently functioning according to the pressure, the output value display unit 500 outputs data according to the pressure value, thereby making it possible to obtain the user desired information. The output value display unit may display an output value through a display, but is not limited thereto. Therefore, the output value display unit may display the output value in various output forms such as sound or music, etc.

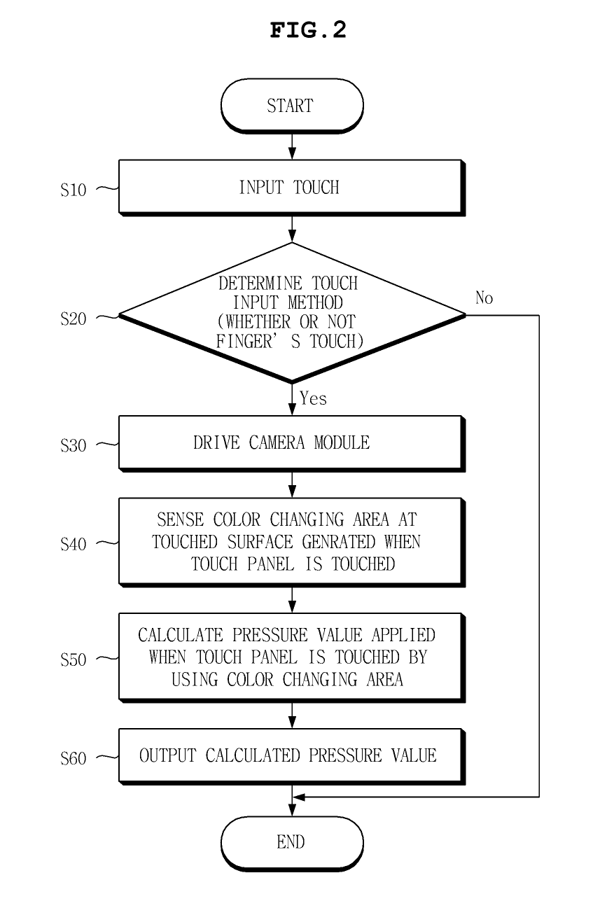

FIG. 2 is a flow chart showing a method of sensing a pressure of a touch panel according to an embodiment of the present invention. A preferred embodiment of the present invention, a method of sensing a pressure of a touch panel includes inputting touch (S10), determining a touch input scheme (S20), driving a camera module according to the determining (S30), sensing a change at a touched surface generated when the touch panel is touched by the driving (S40), calculating a pressure value applied when the touch panel is touched by using the change of the touched surface by the sensing (S50), and displaying an output value of the calculated pressure value (S60).

A first step is the inputting the touch (S10). At the first step, the touch input value is input according to the touch scheme of the user. The touch can be input by various schemes. However, since the present invention senses the pressure applied when the touch panel is touched, it is preferable that the touch is input according to the touch scheme.

A second step is the determining the touch input scheme (S20). The second step is the determining the touch unit touched through the inputting the touch (S10). Generally, the touch is input by a finger in the case of the capacitive type and input by a) tools such as a separate pen, etc., for touch in the case of the resistive type. In addition, in the case of the resistive type, the touch may be input by a finger, etc. However, in the case of the resistive type, a predetermined pressure should be applied and in the case of the capacitive type, the touch can be input by only contacting the touch panel by being touched by the conductive device, etc. In the present invention, the reason for determining the touch input scheme is to sense the pressure applied when the touch panel is touched by driving the camera module. The touch pressure is sensed by the visual change at the touched surface correlated with the pressure applied when the touch panel is touched according to the touch input scheme. Therefore, the process for sensing the pressure is operated according to the touch input scheme correlated between the pressure applied when the touch panel is touched and the visual changes such as the color, the color area, the increase and decrease in the color changing area, etc. In the case of the touch unit that cannot sense the visual change according to the touch pressure by the camera module driver, the pressure sensing of the touch panel ends. As an embodiment of the present invention, FIG. 2 shows a process of the case where the pressure of the touch panel is sensed by sensing the increase and decrease in the color changing area at the surface touched by a finger, as the pressure increases when touch is made by a finger.

A third step is the driving the camera module (S30). The third step senses the visual change such as the color change, the increase and decrease in the color changing area, etc., generated according to the touch pressure at the touched surface when the touch panel is touched by the camera module. The touch pressure applied to the touch panel is calculated in consideration of the correlation between the change at the touched surface sensed by the camera module and the pressure applied when the touch panel is touched. The camera module is driven at a proper position according to the touched coordinate value and is controlled to sense the color change at the touched surface according to the touch pressure.

A fourth step is the sensing the color changing area at the touched surface generate when the touch panel is touched (S40). When the touch panel is touched by a finger, the more the pressure at the surface touched by the finger, the larger the color changing area at the surface touched by the finger becomes. The fourth step calculates the touch pressure value by sensing the shape where the color changing area at the surface touched by the finger is changed according to the pressure applied to the touched pressure.

A fifth step is the calculating the pressure value applied when the touch panel is touched by using the color changing area (S50). The fifth step calculates the color changing area generated at the touched surface according to the pressure applied when the touch panel is touched, which is sensed by the camera module, to convert the calculated color changing area into the touch pressure value. Therefore, the visual factors such as the color change, the increase and decrease in the color changing area, etc., generated at the touched area when the touch panel is touched, which is sensed by the camera module, should have the predetermined correlation with the touch pressure.

A sixth step is the outputting the calculated pressure value (S60). The sixth step is the displaying the user desired output value through the touch pressure calculated at the fifth step. The display of the output value may be visually output through the display and the output value may be displayed in various forms such as sound, music, etc.

According to the present invention, the pressure applied when the central portion and edge portions of the touch panel are touched can be uniformly measured, even in the case of the large-sized touch panel.

Further, the present invention senses the color change of the touch input unit touched on the touched surface through the camera module and calculates the pressure value using the sensed color change, thereby making it possible to measure the pressure applied when the touch panel is touched without mounting the separate pressure sensor.

Further, the present invention senses the color changing area of the touch input unit touched on the touched surface through the camera module and calculates the pressure value using the sensed color changing area, thereby making it possible to measure the pressure applied when the touch panel is touched without mounting the separate pressure sensor.

Although the embodiment of the present invention has been disclosed for illustrative purposes, it will be appreciated that a pressure sensing module of a touch panel and a method of operating the same according to the invention is not limited thereby, and those skilled in the art will appreciate that various modifications, additions and substitutions are possible, without departing from the scope and spirit of the invention. Accordingly, any and all modifications, variations or equivalent arrangements should be considered to be within the scope of the invention, and the detailed scope of the invention will be disclosed by the accompanying claims.

What is claimed is:

1. A pressure sensing module of a touch panel, comprising:
an input unit that inputs a touch;
a controller that controls the sensing of pressure applied when touch is input;
a camera module driver that is driven by the controller;
a calculator that calculates a pressure value applied when the touch panel is touched by using the change at the touched surface sensed by the camera module driver; and
an output value display unit that displays an output value derived from the calculator.

2. The pressure sensing module of a touch panel as set forth in claim 1, wherein the controller determines whether the touch input is made by a finger and if it is determined that the touch input is made by the finger, drives the camera module driver and if it is determined that the touch input is made by units other than the finger, ends the pressure sensing module of the touch panel.

3. The pressure sensing module of a touch panel as set forth in claim 2, wherein the camera module driver senses the color changing area of the surface touched by the finger generated when the touch is made by the finger.

4. The pressure sensing module of a touch panel as set forth in claim 1, wherein the camera module driver senses the color change at the touched surface generated when the touch panel is touched.

5. The pressure sensing module of a touch panel as set forth in claim 1, wherein the camera module driver senses the color changing area at the touched surface generated when the touch panel is touched.

6. A method of operating a pressure sensing module of a touch panel, comprising:
inputting touch;
determining a touch input scheme;
driving a camera module according to the determining;
sensing a change at a touched surface generated when the touch panel is touched by the driving;
calculating a pressure value applied when the touch panel is touched by using the change of the touched surface by the sensing; and
displaying outputs of the calculated pressure value.

7. The method of operating a pressure sensing module of a touch panel as set forth in claim 6, wherein the determining the touch input scheme determines whether the touch input scheme changes colors according to the pressure applied when the touch panel is touched,
if it is determined that the touch input scheme changes colors, the driving the camera module is performed,
the sensing senses the color change at the touched surface when the touch is input by the driving of the camera module,
the calculating calculates the pressure value by using the color change at the touched surface sensed by the sensing, and
if it is determined that touch input schemes other than the touch input scheme changing the color are used, the pressure sensing of the touch panel ends.

8. The method of operating a pressure sensing module of a touch panel as set forth in claim 6, wherein the determining of the touch input scheme determines whether the touch input scheme changes the color changing area according to the pressure applied when the touch panel is touched,
if it is determined that the touch input scheme changes the changing are of color, the driving the camera module is performed,
the sensing senses the color changing area at the touched surface when the touch panel is touched by the driving,
the calculating calculates the pressure value applied when the touch panel is touched by using the color changing area at the touched surface sensed by the sensing, and
if it is determined that touch input schemes other than the touch input scheme changing the color changing area are used, the pressure sensing of the touch panel ends.
